(19) United States
(12) Patent Application Publication
(10) Pub. No.: US 2008/0011953 A1
(43) Pub. Date: Jan. 17, 2008

(54) Scintillator composition, article, and associated method

(75) Inventors: Alok Mani Srivastava, Niskayuna, NY (US); Holly Ann Comanzo, Niskayuna, NY (US); Venkat Subramaniam Venkataramani, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Schenectady, NY (US)

(21) Appl. No.: 11/484,080

(22) Filed: Jul. 11, 2006

(51) Int. Cl. G01T 1/20

(52) U.S. Cl. 250/361 R; 252/301.4 R

(57) ABSTRACT

A scintillator composition is provided. The scintillator composition may include a matrix having at least one lanthanide ion and at least one halide ion, and a dopant. The dopant may include a trivalent cerium activator ion disposed in the matrix, and a trivalent bismuth activator ion disposed in the matrix.

### BACKGROUND

1. Technical Field

The invention includes embodiments that relate to the field of radiation detectors. Embodiments may include a scintillator composition for use in a radiation detector. Embodiments may include a method of making and/or using the scintillator composition.

2. Discussion of Related Art.

Radiation detectors may detect gamma-rays, X-rays, cosmic rays, and particles characterized by an energy level of greater than about 1 keV. Scintillator crystals may be used in such detectors. In these detectors, a scintillator crystal may be coupled with a light-detector, such as a photodetector. When a photon from a radionuclide source impacts the crystal the crystal may emit light in response. The light detector may detect the light emission. In response, the photodetector may produce an electrical signal. The electrical signal may be proportional to the number of light emissions received, and further may be proportional to the light emission intensity. A scintillator crystal may be used in medical imaging equipment, e.g., a positron emission tomography (PET) device; as a well-logging tool for the oil and gas industry; and in other digital imaging applications.

Medical imaging equipment, such as positron emission tomography (PET), may employ a scintillator crystal detector having a plurality of pixels arranged in a circular array. Each pixel may include a scintillator crystal cell coupled to a photomultiplier tube. In PET, a chemical tracer compound having a desired biological activity or affinity for a particular organ may be labeled with a radioactive isotope. The isotope may decay by emitting a positron. The emitted positron may interact with an electron, and may provide two 511 keV photons (gamma rays). The two photons are emitted simultaneously and travel in almost exactly opposite directions, penetrate the surrounding tissue, exit the patient's body, and are absorbed and recorded by the detector. By measuring the slight difference in arrival times of the two photons at the two points in the detector, the position of the positron emission inside the target can be calculated. Naturally, the positron emission coincides with the position of the isotope, and of the tissue or organ labeled by the isotope. A limitation of this time difference measurement may include the stopping power, light output, and decay time of the scintillator composition.

Another application for a scintillator composition is in a well-logging tool. The detector in this case captures radiation from a geological formation, and converts the captured radiation into a detectable light emission. A photomultiplier tube may detect the emitted light. The light emissions may transform into electrical impulses. The scintillator composition, and associated hardware, must function at high temperature, as well as under harsh shock and vibration conditions. A nuclear imaging device may encounter high temperature and high radiation levels.

It may be desirable to have a scintillator composition and an article employing a scintillator composition that has one or more properties and characteristics that differ from those currently available. It may be desirable to have a method of making and/or using a scintillator composition that may differ from those currently available.

### BRIEF DESCRIPTION

In one embodiment, a scintillator composition is provided. The scintillator composition may include a matrix having at least one lanthanide ion and at least one halide ion, and a dopant. The dopant may include a trivalent cerium activator ion disposed in the matrix, and a trivalent bismuth activator ion disposed in the matrix.

In one embodiment, a scintillator composition is provided. The scintillator composition includes a reaction product of a matrix forming material, a lanthanide halide precursor, and a dopant. The dopant includes a trivalent cerium activator ion precursor and a trivalent bismuth activator ion precursor.

In one embodiment, a wafer is provided. The wafer includes a scintillator composition according to an embodiment of the invention. In one embodiment, an article includes the wafer.

In one embodiment, a radiation detector for detecting high-energy radiation is provided. The radiation detector may include a scintillation element formed from a scintillator composition. The scintillator composition may include a matrix comprising a lanthanide halide. The lanthanide halide may include at least one lanthanide ion and at least one halide ion. Further, the scintillator composition may include a dopant having a trivalent cerium activator ion disposed in the matrix, and a trivalent bismuth activator ion disposed in the matrix.

In one embodiment, a method of manufacturing a scintillator composition is provided. The method includes contacting at least one lanthanide ion precursor and at least one halide ion precursor, a trivalent cerium activator ion precursor, and a trivalent bismuth activator ion precursor in a ratio to form a mixture. The mixture may be heated to a temperature to form a molten composition. The molten composition may cool to form a crystalline scintillator composition. Another method includes exposing a scintillator composition to a radiation source according to an embodiment of the invention.

In one embodiment, a scintillator composition is provided. The scintillator composition may include a reaction product of a matrix forming material, a lanthanide halide precursor, and a dopant comprising a trivalent cerium activator ion precursor and a trivalent bismuth activator ion precursor.

### BRIEF DESCRIPTION OF THE DRAWINGS

These and other features and aspects may be apparent in view of the detailed description and accompanying drawing figures in which like reference numbers represent parts that are the same, or substantially the same, from figure to figure.

FIGS. 1 and 2 are flow charts illustrating exemplary methods for manufacturing a scintillator composition in accordance with an embodiment of the invention.

FIG. 3 is a diagrammatical representation of an exemplary radiation-based imaging system employing a scintillator composition in accordance with an embodiment of the invention.

FIG. 4 is a diagrammatical representation of an exemplary positron emission tomography imaging system employing a scintillator composition in accordance with an embodiment of the invention.

FIG. 5 is a front view of an exemplary scintillator ring used in a radiation detector of a positron emission tomography imaging system in accordance with an embodiment of the invention.

### DETAILED DESCRIPTION

The invention includes embodiments that relate to the field of radiation detectors. Embodiments may include a scintillator composition for use in a radiation detector. Embodiments may include a wafer including the scintillator composition, an article including the wafer, and a method of making and/or using the scintillator composition, the wafer, and/or the article.

As used herein, light output refers to a quantity of light emitted by a scintillator composition after excitation by a pulse of the X-ray or gamma ray. Unless specified otherwise, light refers to visible light. Decay time refers to the time required for the intensity of the light emitted by the scintillator to decrease to a specified fraction of the light intensity after radiation excitation ceases. Afterglow refers to the light intensity emitted by the scintillator at a specified time (e.g., 100 milliseconds) after radiation excitation ceases. Afterglow may be reported as a percentage of the light emitted while the scintillator is excited by the radiation. Stopping power refers to the ability of a material to absorb radiation, and may be referred to as the material's X-ray absorption or X-ray attenuation. Attenuation length refers to a distance inside the material, which a photon has to travel before the energy of the photon is absorbed by the material. Energy resolution refers to a radiation detector ability to distinguish between energy rays (e.g., gamma rays) having similar energy levels. As used herein, the term “solid solution” refers to a mixture of the halides in solid, crystalline form, which may include a single phase, or multiple phases. A scintillator is a device or substance that absorbs high energy (ionizing) electromagnetic or charged particle radiation and fluoresces photons at a characteristic (longer) wavelength in response. A matrix refers to a material of the scintillator composition, which has a higher volume fraction relative to other materials present in the scintillator composition. A dopant refers to two or more activator ions, which may be substituted or atomically dispersed in the matrix. An activator ion is raised to an excited state by absorbing radiation of suitable wavelengths, and returns to the ground state by emitting radiation. Z(effective) is the amount of positive charge on the nucleus perceived by an electron.

Approximating language, as used herein throughout the specification and claims, may be applied to modify any quantitative representation that could permissibly vary without resulting in a change in the basic function to which it is related. Accordingly, a value modified by a term or terms, such as about, may not to be limited to the precise value specified. In at least some instances, the approximating language may correspond to the precision of an instrument for measuring the value. Similarly, free may be used in combination with a term, and may include an insubstantial number, or trace amounts, while still being considered free of the modified term.

A scintillator composition according to an embodiment of the invention may include a matrix having at least one lanthanide ion and at least one halide ion. The scintillator composition may further include a dopant. The dopant may include a trivalent cerium activator ion disposed in the matrix, and a trivalent bismuth activator ion disposed in the matrix.

An activator ion may produce luminescence by absorption of the electrons and release of the excitation energy as photons of particular wavelengths. The activator ion luminescence may, in turn, activate a scintillator ion and cause the scintillator ion to emit light. Hence, it may be sometimes desirable to have a combination of activator ion and scintillator ion, which are mutually amicable. For example, the activator ion, such as bismuth, may facilitate transport of energy from the charge carriers to the scintillator ion.

The total amount of the dopant present in the scintillator composition may be selected based on particular factors. Such factors may include, for example, the particular halide-lanthanide matrix being used; the desired emission properties and decay time; and the type of detection device into which the scintillator composition is being incorporated.

The scintillator composition may include lutetium as the lanthanide ion. The lanthanide ion may include less than about 70 mole percent of lutetium. In one embodiment, the lanthanide ion may include lutetium in an amount in a range of from about from about 50 mole percent to about 70 mole percent, from about 70 mole percent to about 90 mole percent, or from about 90 mole percent to about 100 mole percent. In one embodiment, the lanthanide ion may consist essentially of lutetium.

The scintillator composition may include an amount of lutetium in combination with one or more other lanthanide ions. Other suitable lanthanide ions may include one or more of scandium, yttrium, gadolinium, lanthanum, praseodymium, terbium, europium, erbium, ytterbium, or combinations of two or more thereof.

A suitable halide ion may include one or more of fluorine, chlorine, bromine, or iodine. Iodine may be present in an amount in a range of greater than about 95 mole percent. In one embodiment, the scintillator composition may include iodine in an amount in a range of from about 80 mole percent to about 85 mole percent, from about 85 mole percent to about 95 mole percent, or from about 95 mole percent to about 100 mole percent.

In one embodiment, the halide ion may include iodine and may be in combination with one or more of fluorine, chlorine, or bromine. The fluorine, chlorine, or bromine may be present in an amount in a range of greater than about 50 mole percent of the total amount of the halide ion present in the scintillator composition. In one embodiment, the amount may be in a range of from about 5 mole percent to about 15 mole percent, from about 15 mole percent to about 25 mole percent, from about 25 mole percent to about 50 mole percent, or more than about 50 mole percent of the total amount of the halide ion present in the scintillator composition.

The matrix material may include a mixture of lanthanide and halide ions. In one embodiment, the matrix material may include a solid solution of a mixture of one or more lanthanide halides. A plurality of differing lanthanide halides may be used for the scintillator composition. The mixture may include lutetium iodide. In one embodiment, lanthanide chlorides, lanthanide fluorides, or lanthanide bromides may also be used in combination with lutetium iodides. In one embodiment, the mixture may consist essentially of lutetium iodide. In addition to lutetium iodide, the mixture may also include gadolinium chloride, yttrium chloride, or both. Other non-limiting examples of suitable lanthanide halides include lutetium chloride, lutetium bromide, yttrium chloride, yttrium bromide, gadolinium chloride, gadolinium bromide, praseodymium chloride, praseodymium bromide, and mixtures of two or more thereof. A combination of lutetium chloride and lutetium bromide may be used as a matrix material. The ratio of the lutetium chloride and lutetium bromide may be a molar ratio in the range of about 1:99 to about 99:1. As specific examples of useful ratios for this combination, the molar ratio of lutetium chloride to lutetium bromide may be in a range of from about 10:90 to about 90:10, from about 15:85 to about 30:70, from about 30:70 to about 50:50, from about 50:50 to about 70:30, from about 85:15 about 90:10, and less than about 90:10. Other combinations may have the same molar ratio as disclosed for lutetium chloride and lutetium bromide.

The specific ratio of the two compounds may be based on desired properties of the scintillator composition. Such properties may include, for example, light output and energy resolution, rise time, decay time, stopping power, or combinations of two or more thereof. A scintillator composition having a high stopping power may allow little or no incident radiation, such as gamma radiation, to pass through. The stopping power may be directly related to the density of the scintillator composition. In one embodiment, the scintillator composition may have a high density, which may be near a theoretical maximum density. Higher light output may lower an amount of incident radiation required for the desired end use. Thus, in applications such as PET the patient may be exposed to a relatively lower dose of radioactive material. Shorter decay time may reduce the scan time resulting in more efficient use of the PET system and better observation of the motion of a body organ. Higher stopping power may reduce the quantity of scintillator composition needed for the end use. Thinner detectors have a reduced quantity of material and a lower cost of manufacture. A thinner detector may reduce the absorption of emitted light.

The reaction product of the mixture of halides may result in a scintillator composition with a relatively increased light output response. In one embodiment, the light output of the scintillator composition may be in a range of from about 45000 photons per milli electron volt to about 10000 photons per milli electron volt, from about 10000 photons per milli electron volt to about 50000 photons per milli electron volt, from about 50000 photons per milli electron volt to about 100000 photons per milli electron volt, or greater than about 100000 photons per milli electron volt.

As discussed above, the scintillator composition may include a dopant. The dopant may include a cerium activator ion and a bismuth trivalent activator ion. The selection of the dopant and the amount of the dopant present in the scintillator composition may depend on various factors, such as the particular lanthanide halide matrix being used, the desired emission properties and decay time, after glow, and/or the type of detection device into which the scintillator is being incorporated. As decay time of the cerium ion may be in the nanoseconds range, and since the bismuth ions may facilitate transport of the excitation energy of the cerium ions, such a scintillator composition may have a decay time in the nanoseconds range.

In one embodiment, the amount of the dopant in the scintillator composition may be in a range of from about 0.1 mole percent to about 1 mole percent, from about 1 mole percent to about 5 mole percent, from about 5 mole percent to about 10 mole percent, from about 10 mole percent to about 15 mole percent, from about 15 mole percent to about 20 mole percent, or greater than about 20 mole percent, based on the total moles of the dopant in the matrix.

The trivalent cerium activator ion may be present in an amount in a range of from about 0.1 percent to about 0.5 percent, 0.5 percent to about 2 percent, from about 2 percent to about 5 percent, from about 5 percent to about 8 percent, from about 8 percent to about 10 percent, or more than about 10 percent, based on the total percent of the dopant. The trivalent bismuth activator may be present in the activator ion in an amount in a range of from 0.1 percent to about 0.5 percent, 0.5 percent to about 2 percent, from about 2 percent to about 5 percent, from about 5 percent to about 8 percent, from about 8 percent to about 10 percent, based on the total percent of the dopant. The relative amounts of the two activator ions may be employed based upon the desired properties, such as stopping power, of the resulting scintillator composition. The stopping power of the scintillator composition may be measured in terms of the Z(effective). For example, the Z(effective) of lutetium iodide (LuI₃) may be 61, while that of Lu_{0.80}Bi_{0.20}I₃ may be 63.

The cerium and bismuth co-doped scintillator composition may exhibit higher energy resolution as compared to only cerium or only bismuth doped scintillator composition. As mentioned, the bismuth ion may facilitate transport of the excitation energy of the cerium ion to the matrix material.

In one embodiment, the energy resolution of the scintillator composition may be less than about 2.5 percent. In another embodiment, the energy resolution of the scintillator composition may be in a range of from about 2.5 percent to about 5 percent, from about 5 percent to about 6 percent, or from about 6 percent to about 7 percent, or greater than about 7 percent.

The scintillator composition may be prepared in several different forms, depending on its intended end use. For example, the scintillator composition may be in mono-crystalline (i.e., “single crystal”) form or in polycrystalline form. In one embodiment, the single crystal scintillator composition may include more than one grains. The grains in the single crystal may be delineated by small-angle grain boundaries, which may appear at the surface of the single crystal or may be evident under strong illumination due to scattering by impurities on the small-angle grain boundaries. Single crystals having a few grain boundaries may be sometimes referred to as “quasi-single” crystals.

The single crystal may be useful for high-energy radiation detectors, e.g., those used for gamma rays. The single crystal may have a different optical transparency in the emission region as compared to polycrystalline scintillator compositions. The single crystal transparency may allow the emission radiation to escape efficiently. Also, the absence of scattering centers, such as grain boundaries, may result in relatively higher light outputs. The single crystal may be useful in imaging systems, such as PET, where the amount of radiation incident on the scintillator composition may be relatively low.

In one embodiment, the crystal size of the single crystal scintillator composition may be in a range of from about 1 centimeter×1 centimeter to about 3 centimeters×3 centimeters, from about 3 centimeters×3 centimeters to about 7 centimeters×7 centimeters, or from about 7 centimeters×7 centimeters to about 10 centimeters×10 centimeters, or greater than about 10 centimeters×10 centimeters.

Alternatively, the scintillator composition may be in a polycrystalline form. The polycrystalline form may be made of plurality of crystallites or grains, which may be separated by grain boundaries. In one embodiment, the crystallite size of the polycrystalline form may be in a range of from about 1 micrometer to about 5 micrometers, from about 5 micrometers to about 10 micrometers, from about 10 micrometers to about 15 micrometers, from about 15 micrometers to about 20 micrometers, or greater than about 20 micrometers.

In one embodiment, the scintillator composition is prepared as a powder form by using the dry process. The process may include the steps of preparing a suitable powder mixture containing the ingredients in determined proportions. In one embodiment, the halide reactants may be supplied in powder form.

The density of the scintillator composition employed in the scintillation element may be in a range of greater that about 6 grams per cubic centimeter. In one embodiment, the density of the scintillator composition may be in a range of from about 4.5 grams per centimeter cube to about 5 grams per centimeter cube, or from about 5 grams per centimeter cube to about 6 grams per centimeter cube.

The mixing of the reactants may be carried out by using an agate mortar and pestle. Alternatively, a blender or pulverization apparatus may be used, such as a ball mill, a bowl mill, a hammer mill, or a jet mill.

Depending on compatibility and/or solubility, heptane, or an alcohol such as ethyl alcohol sometimes may be used as a liquid vehicle during milling. Milling media may be selected to reduce contamination in the scintillator composition. Non-contaminating milling media may be used to maintain high light output capability of the scintillator composition.

After blending, the mixture is fired under temperature and time conditions sufficient to convert the mixture into a solid solution. These conditions will depend in part on the specific type of matrix material and activator being used. Firing may be carried out in a muffle furnace, at a temperature in the range of from about 500 degrees Celsius to about 600 degrees Celsius, from about 600 degrees Celsius to about 700 degrees Celsius, from about 700 degrees Celsius to about 800 degrees Celsius, from about 800 degrees Celsius to about 900 degrees Celsius, or greater than about 900 degrees Celsius. The firing time may be in a range of from about 15 minutes to about 1 hour, from about 1 hour to about 2 hours, from about 2 hours to about 4 hours, from about 4 hours to about 5 hours, from about 5 hours to about 7 hours, from about 7 hours to about 10 hours, or greater than about 10 hours.

Firing may be carried out in an oxygen-free and water-free (or moisture-free) atmosphere. Examples of oxygen-free environments may include one or more inert gases. Inert gases may include one or more of nitrogen, helium, neon, argon, krypton, and xenon. After firing is complete, the resulting material may be pulverized, to put the scintillator into powder form.

In one embodiment, the firing temperatures may be chosen such that the scintillator composition is a solid solution. A solid solution may produce a scintillation element having uniform composition, a desirable refractive index, uniformity of the refractive index throughout the scintillation element, and relatively higher light output.

The reactants and processing conditions may be selected to produce a single crystal. The reactants melt at a temperature sufficiently high to form a molten composition under single crystal formation processes. The melting temperature may depend on the identity of the reactants themselves. Suitable melting temperatures may be in a range of about 650 degrees Celsius to about 800 degrees Celsius, from about 800 degrees Celsius to about 950 degrees Celsius, from about 950 degrees Celsius to about 1050 degrees Celsius, or greater than about 1050 degrees Celsius. In the case of lutetium halides with a cerium and bismuth-based activator ions, the melting temperature may be in a range of from about 750 degrees Celsius to about 1050 degrees Celsius.

In one process, a seed crystal for the desired scintillator composition is introduced into a saturated solution. A suitable crucible contains the solution and appropriate precursors for the scintillator composition. A crystalline material is allowed to grow and add to the seed crystal by using crystal growth methods, such as, for example the Bridgman-Stockbarger methods, the Czochralski method, the zone-melting method, the floating zone method, or the temperature gradient method. The size, shape, surface properties, composition, crystallinity of the single crystal scintillator composition so formed depends in part on its desired end use, e.g., the type of radiation detector in which the single crystal scintillator composition will be incorporated. The radiation detector may be in operative association with a screen scintillator. The radiation detector may employ a portable housing and an energy storage device, which together are sized, weighted, and configured so that the radiation detector is portable by a single person.

As disclosed above, the compacted shape may be annealed to equilibrate the activator ions to a determined valence state to increase light yield and to decrease absorption. Cerium may be the activator, and the annealing atmosphere and temperature may be maintained so as to equilibrate cerium to a 3+ valence state. Cerium in the 3+ valence state acts as an activator ion, producing light in the presence of suitable wavelengths of radiation.

The scintillation element formed after processing the single crystal may be polished after cutting into desired shapes, such as rods, cubes; cuboids, trapezoids, cones, or other geometric shapes. Re-crystallization of the scintillator composition may allow for the net-shape fabrication of light piping structures, such as rods or fibers that find applications in long-distance fiber optics. The scintillation element may be coated with a reflector material to form a detector element. In one embodiment, the reflector material may include a halogenated polyolefin, such as polytetrafluoroethylene. For example, the reflector material may be applied on individual scintillation elements in an array of scintillation elements to reduce cross talk of light between the elements. Further, a coated array of scintillation elements may be then employed in a radiation detector system.

The scintillator composition may be formed into a wafer by growing into a boule or ingot and cutting or dicing, or by pressing or sintering at a reflow temperature. In one embodiment, the wafer may be a continuous film or sheet. In another embodiment, the wafer may be a non-continuous film or sheet. The non-continuous wafer may have several sub-portions that are separate, insulated, or spaced from each other. For example, the non-continuous wafer may be a combination of several pixels or pixel elements. The pixels may be formed by partially masking the substrate during deposition of the wafer. In application such as PET, the pixels may be equi-sized. Each of the pixels of the non-continuous wafer may form an individual detector element. In case of the continuous wafer, the wafer may be cut or divided into a plurality of pixels to form an array of detector elements. The pixels of the continuous or non-continuous wafer may be coated with the reflector material to form the detector element. For example, the reflector material may be applied on the individual pixels in an array of the pixels. Further, the coated array of the pixels may be then employed in a radiation detector system.

The wafer may be supported by a substrate. Alternatively, the wafer may be formed as an independent free-standing layer. In one embodiment, the wafer may have uniform thickness. In another embodiment, the wafer may have a thickness that differs in one area relative to another area. The wafer may have an average thickness of less than about 5 millimeters. In one embodiment, the wafer may have an average thickness in a range of from about 5 millimeters to about 7.5 millimeters, from about 7.5 millimeters to about 1 centimeter, from about 1 centimeter to about 2 centimeters, from about 2 centimeters to about 3 centimeters, or greater than about 3 centimeters. The thickness of the wafer may be selected based on the desired energy response with regard to the stopping power of the scintillator composition. In one embodiment, the wafer may have a flat surface. In another embodiment, the wafer may have a bowed, curved or de-shaped surface.

The scintillator composition may be employed in applications such as positron emission tomography (PET), which is a medical imaging technique in which a radioactive substance is administered to a patient and then traced within the patient's body by an instrument that detects the decay of the radioactive isotope. In PET, a chemical tracer compound having a desired biological activity or affinity for a particular organ is labeled with a radioactive isotope that decays by emitting a positron. The emitted positron loses most of its kinetic energy after traveling only a few millimeters in a living tissue. The positron is susceptible to interaction with an electron, an event that annihilates both particles. The mass of the two particles (positron+electron) is converted into 1.02 million electron volts (1.02 milli electron volt) of energy, divided equally between two 511 keV photons (gamma rays). The two photons are emitted simultaneously and travel in almost exactly opposite directions. The two photons penetrate the surrounding tissue, exit the patient's body, and are absorbed and recorded by photo detectors arranged in a circular array. Tracing the source of the radiation emitted from the patient's body to the photo detectors can assess biological activity within an organ under investigation.

The economic value of PET as a clinical imaging technique may relate to the performance of the photo detectors. Each photodetector includes a scintillator cell or pixel. The scintillator cell or pixel may couple to one or more photomultiplier tubes. The scintillator cell produces light at the two points where the 511 KeV photons impact the scintillator cells. The light produced by the two scintillator cells is sensed by the corresponding coupled photomultiplier tubes. Approximate simultaneous interaction of the photons on the scintillator cells indicate the presence of a positron annihilation along the line joining the two points of interaction. The photomultiplier tubes generate an electrical signal in response to the produced light. By measuring the slight difference in arrival times (time of flight) of the two photons at the two points in scintillator cell, the position of positron can be calculated. The electrical signals from the photomultiplier tubes are processed to produce an image of the patient's organ.

In the case of living targets such as human beings or animals, a minimal amount of the radioactive substance is administered inside the target in order to reduce adverse affects of the radioactive isotope. The minimal amount may be sufficient to produce a detectable amount of lesser energy photons. However, lesser energy photons may require a scintillator composition with sufficiently high sensitivity, density, and luminous efficiency. Also, a short decay time may reduce the integration time during the determination of the intensity of the input radiation, so that the image rate for the generation of images and/or projections can increase. As a result, the occurrence of artifacts, such as shadow image, may be reduced. Moreover, examination time may be reduced for the patient because more single images can be measured within a shorter period of time. Stopping power relates to the density of the scintillator composition. Scintillator compositions which have high stopping power allow little or no radiation to pass through, and this is a distinct advantage in efficiently capturing the radiation.

A shorter decay time may facilitate efficient coincidence-counting of gamma rays. Consequently, a shorter decay time may reduce scan times. Reduced afterglow may sharpen the image at the scintillator cell. In one embodiment, the reduced afterglow may be free from image artifacts (ghost images). As disclosed above, stopping power relates to the density of the scintillator composition. In one embodiment, the scintillator composition has a stopping power that allows little or no radiation to pass through, and may efficiently capture the incident radiation.

A timing resolution on the order of 4 nanoseconds constrains the positron to a 50 centimeters square region. As 50 centimeters square is about the size of an average human body, a timing resolution on the order of 4 provides little information regarding the location of an annihilation point in the body. A timing resolution of about 0.5 nanoseconds constrains the positron to about a 5 centimeters square region. Embodiments of detector elements including the disclosed scintillator composition have a relatively fast rise time, fast decay time, and high light output. The rise time may be less than about 4 nanoseconds. In one embodiment, the rise time may be in a range of from about 10⁻¹¹ seconds to about 10⁻¹⁰ seconds, from about 10⁻¹⁰ seconds to about 10⁻⁹ seconds, from about 10⁻⁹ seconds to about 10⁻⁸ seconds, or less than about 10⁻¹¹ seconds. The decay time of a detector element including a scintillator composition may be less than about 50 nanoseconds. In one embodiment, the decay time may be in a range of from about 20 nanoseconds to about 30 nanoseconds, from about 30 nanoseconds to about 40 nanoseconds, or from about 40 nanoseconds to about 50 nanoseconds. The density of a detector element including a scintillator composition allows reduced thickness of the wafer of the scintillator composition. The reduced thickness may allow for reduced scattering of the photons in the detector element including the scintillator composition.

The scintillator composition may be employed in a time-of-flight (TOF) radiation detector. An exemplary measure of the efficacy of the TOF detector is the number density of photons per unit time. TOF refers to the transit of the photons from their source in the body to the PET scanner's scintillator ring. In a TOF detector, the detection of a photon by a detector of the detector ring or the scintillator ring results in the opening of an electronic time window, during which detection of a photon at the other detector of the detector ring results in the counting of a coincidence event. Not only are the photons detected inside the time window, but also the difference in time-of-flight between the two photons is measured and used to estimate a more probable location of the annihilation point along the line. This may reduce the signal to noise ratio and may boost the image quality. Measuring the slight difference in the arrival times of two photons emitted from the same positron with sufficiently good timing resolution may determine where along the line the positron was originally located within the target.

Although, the scintillator composition is described with respect to a PET imaging system, the scintillator composition may be used in other applications that benefit from similar properties. For example, the scintillator composition may be a down-hole detector or well-logging tool.

The well-logging tool may include a radiation detector assembly. The radiation assembly may be placed in or coupled to a tool housing that is a drill or bore assembly. The radiation detector assembly employs a scintillator composition and a light-sensing device (e.g., photomultiplier tube) optically coupled together by an optical interface. The light-sensing device converts the light photons emitted from the scintillator composition into electrical pulses that are shaped and digitized by associated electronics. The detector assembly captures radiation from the surrounding geological formation. The radiation may be converted into light. The generated light transmits to the light-sensing device. The light impulses transform into electrical impulses. The scintillator composition, the light-sensing device, and the optical interface may be sealed inside a detector housing. The optical interface includes a window coupled to the detector housing. The window facilitates radiation-induced scintillation light to pass out of the detector housing for measurement by the light-sensing device. The optical window may be made of a material that is transmissive to scintillation light given off by the scintillator composition. The detector casing may be made of metal, such as stainless steel, or aluminum. A detector cable connects the detector assembly to a power source and data processing circuitry. Data based on the impulses from the photomultiplier tube may be transmitted “up-hole” to analyzing equipment and the data processing circuitry. Alternatively, the data may be stored locally downhole. The data processing unit electrically couples to an operator workstation. The operator workstation couples to an output device.

Sometimes the data may be obtained and transmitted while drilling, i.e., “measurements while drilling” (MWD). The scintillation element in the well-logging tool can function at high temperatures and under harsh shock and vibration conditions. The scintillator composition may have one or more properties discussed previously, e.g., high light output and energy resolution, as well as fast decay time. The scintillator composition fits in package suitable for a constrained space. The threshold of the acceptable properties has been raised considerably as drilling is undertaken at much greater depths. In another embodiment, the apparatus can be configured for use as a nuclear imaging device.

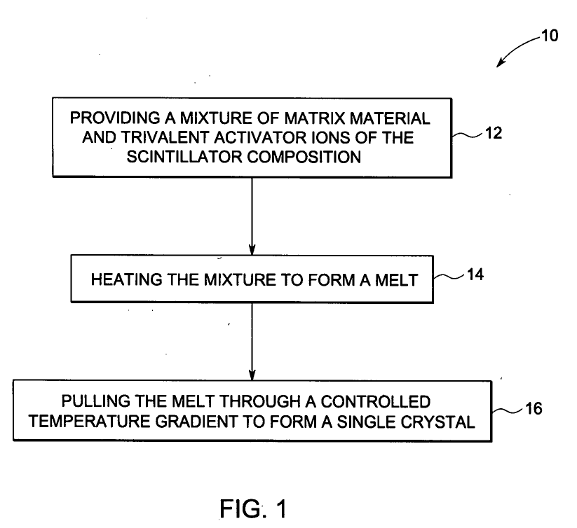

FIG. 1 is a flow chart illustrating one exemplary process 10 for manufacturing a scintillator composition. As illustrated, the process 10 begins by providing a mixture of precursors of the scintillator composition in determined amounts (block 12) and, one or more additives. The mixture is subjected to grinding, such as ball milling. The mixture is placed in a crucible and heated to a temperature greater than the melting point of the mixture to convert the mixture into a melt of the scintillator composition (block 14). The heating is carried out at ambient pressure. Subsequently, the melt of the scintillator composition is pulled through a controlled temperature gradient to form a single crystal (block 16). Optionally, the single crystal so formed may be cut into desired shapes and post-processed. Suitable shapes include wafers, and post processing can include polishing, grinding, and surface planarization.

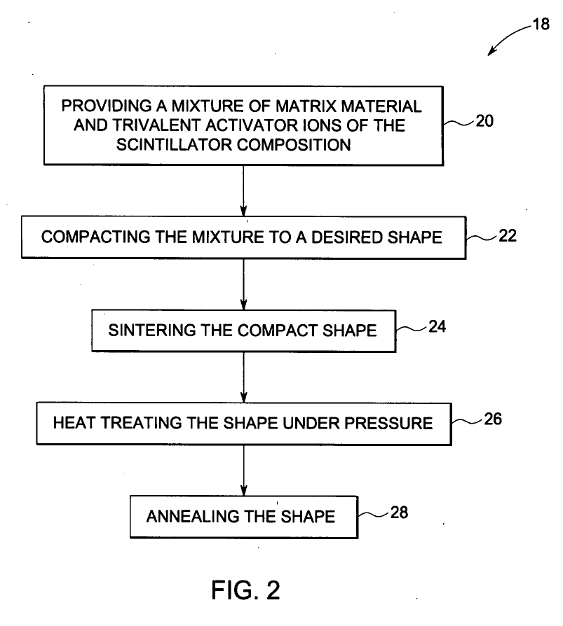

FIG. 2 is a flow chart illustrating an exemplary process 18 of manufacturing a scintillator composition in accordance with embodiments of the invention. The process 18 provides a precursor mixture of the scintillator composition (block 20). The precursor mixture may be compacted into a desired shape (block 22). In some cases, the compacted shape may be sintered to densify the compact form (block 24). The sintering is performed at a halogen partial pressure of about 10⁻⁴ Torr. At block 26, the shape so formed is heat treated under pressure to reduce the porosity of the shape. At block 28, the shape is annealed to equilibrate the activator ion to a valence state to increase light yield and to decrease absorption. Cerium is the activator, and the annealing atmosphere and temperature are maintained so as to equilibrate cerium to a 3+ valence state.

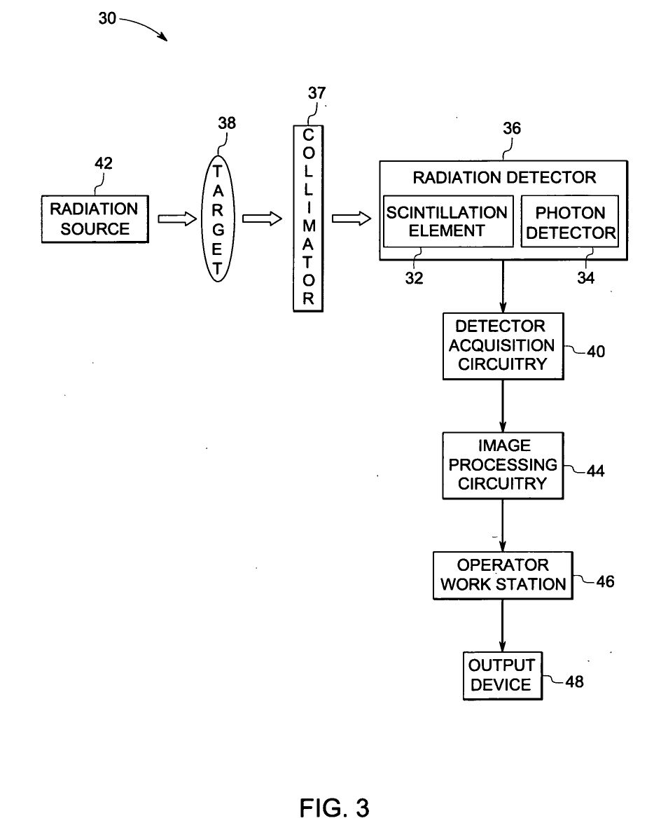

Referring to FIG. 3, an imaging system 30 employing a scintillation element 32 and a photon detector 34 in a radiation detector 36 is illustrated. The photon detector 34 detects photons produced by the scintillation element 32. The photon detector 34 includes a photodiode. The photodiode converts the photons into respective electrical signals. The photon detector 34 may be coupled to a photomultiplier tube to enhance the electrical signals produced by the photon detector 34. The imaging system 30 processes the electrical signals to construct an image of the internal features within the target 38. A collimator 37 may collimate beams directed towards the radiation detector 36. Collimation may enhance the absorption percentage of the incident light on the radiation detector 36.

The radiation detector 34 couples to detector acquisition circuitry 40. The acquisition circuitry 40 controls acquisition of the signals generated in the photon detector 34. The radiation detector 34 includes a photomultiplier tube, a photodiode, a charge-coupled device (CCD) sensor, and an image intensifier. The imaging system 30 includes a motor subsystem (not shown) to facilitate motion of the radiation source 42, and/or the detector 34. The image processing circuitry 44 examines protocols and processes acquired image data from the detector acquisition circuitry 40.

As an interface to the imaging system 30, one or more operator workstations 46 may be included for outputting system parameters, requesting examination, viewing images, and so forth. The operator workstation 48 enables an operator, via one or more input devices (keyboard, mouse, touchpad, etc.), to control one or more components of the imaging system 30 if necessary. The illustrated operator workstation 46 couples to an output device 48, such as a display or printer, to output the images generated during operation of the imaging system 30. Displays, printers, operator workstations, and similar devices may be local or remote from the imaging system 30. For example, these interface devices may be positioned in one or more places within an institution or hospital, or in a different location. Therefore, the interface devices may be linked to the image system 30.

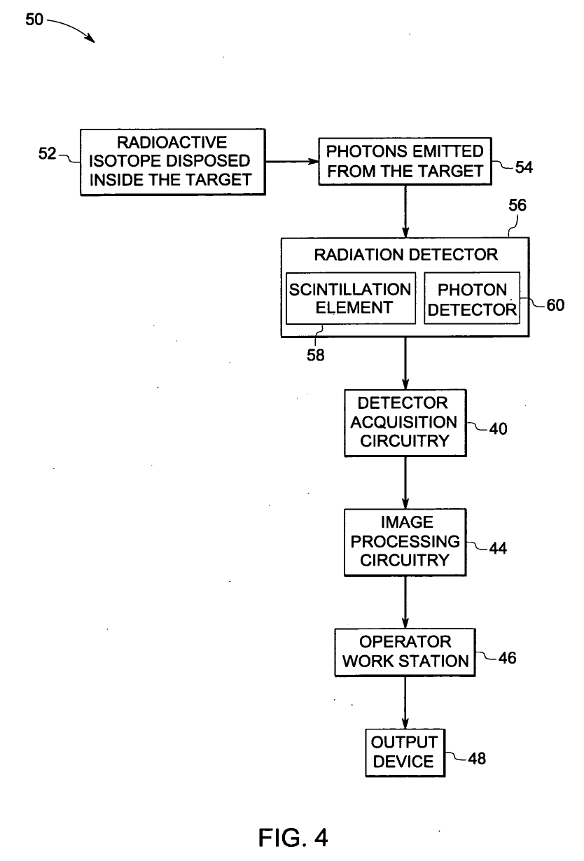

FIG. 4 illustrates a PET imaging system 50 employing a scintillation element 58. In the illustrated embodiment, the PET imaging system 50 includes a radioactive isotope 52 disposed within a target. The target may be a human with a radioactive isotope injected inside. The radioactive isotope is administered to desired locations inside a human by tagging it along with a natural body compound, such as glucose, ammonia, or water. After the dose of the radioactive isotope is administered inside the target, the radioactive substance; during its lifetime, emits radiation 54 that may be detected by the radiation detector 56 (scintillator 58 and photon detector 60). Once inside the target (e.g., body of human), the radioactive substance 52 localizes the radioactivity in the biologically active areas or areas to be detected.

In the illustrated embodiment, the radiation detector or the PET scanner 56 includes a scintillation element 58 having the scintillator composition. The radiation detector 56 includes a photon detector 60, such as a photodiode. Further, the PET imaging system 50 includes detector acquisition circuitry 40, image processing circuitry 44, operator workstation 46, and an output device 48 as described with reference to imaging system 30 of FIG. 3.

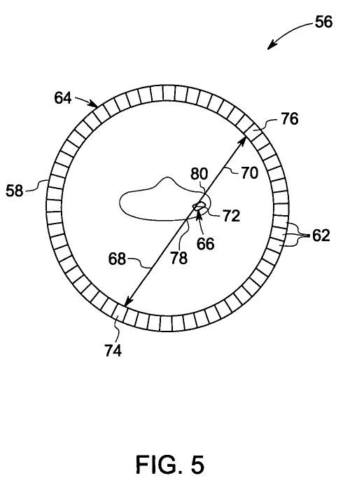

FIG. 5 is a cross sectional view of the radiation detector 56 employed in the PET imaging system 30 shown in FIG. 3. In the illustrated embodiment, the radiation detector 56 employs a plurality of detector elements 62. The detector elements 62 are arranged around the target in a cylindrical configuration with a circular cross section. The circular cross section enables the two photons penetrated out of the target to reach any two opposite detector elements located on the scintillator ring 64. The scintillator ring 64 includes one or more layers of the scintillator element 58. The ring 64 is disposed over a layer of photon detectors 60. The scintillator element 58 includes pixels, each of which couples to a pixel of the photon detector (not shown). In other words, one or more layers having an array formed by the pixels of the scintillator element 58 may be disposed over another layer, which is formed by an array of the pixels of the photon detector 60.

In the illustrated embodiment, a target having a radioactive isotope localized in a biologically active region 66 is disposed inside the radiation detector 56. As described above, the radioactive isotope emits a positron upon decay. The decay is beta decay. The emitted positron travels at a high speed and is slowed to smaller speeds due to collisions with neighboring atoms. Once the positron is slowed, the annihilation reaction takes place between the positron and an outer-shell electron of one of the neighboring atoms. The annihilation reaction produces two 511 KeV photons or gamma rays, which travel in almost exactly opposite directions as shown by arrows 68 and 70 due to conservation of energy and momentum. The two detector points along with the origin point 72 of the photon in the biologically active region 66 form a straight line. The origin point 72 in the biologically active region 66 occurs along a straight line connecting the two detector elements 74 and 76. The two photons traveling in the direction shown by the arrows 68 and 70 reach the detector elements 74 and 76 respectively, such that the points 72, 74 and 76 lay on the same straight line. Simultaneous detection of photons on two points of the scintillator ring 64 indicates existence of the radioactive isotope in an identifiable location. The location is associated with a biologically active area in a human target.

Furthermore, for the PET imaging system 34 (see FIG. 2), the energy of the photons detected by the radiation detector 40 determines that the two photons follow their original trajectory as shown by arrows 68 and 70. Although some scattering may occur. Scattering may include Compton scattering or elastic scattering. A scatter correction may be employed in the radiation detector system to account for elastic scattering. An energy discriminator may be employed in the radiation detector system to account for Compton scattering. The scattered photons exhibit energy values lower than 511 KeV. The level of the signal from the radiation detector system determines what is the energy level of the photons. Therefore, the scintillator element returns to the normal or ground state before receiving a photon. If the scintillator composition is in the excited state while receiving the next photon, an energy value of 511 KeV may be incorrectly registered despite the fact that the photon quantum was scattered and has a lower energy value. The photons pass through target material, such as tissues in case of humans or animals, during the travel from the origin 72 to the locations 78 and 80 where the photons emerge from the target 38. Consequently, some energy of the photons may be lost due to interactions in the target material.

Reference is made to substances, components, or ingredients in existence at the time just before first contacted, formed in situ, blended, or mixed with one or more other substances, components, or ingredients in accordance with the present disclosure. A substance, component or ingredient identified as a reaction product, resulting mixture, or the like may gain an identity, property, or character through a chemical reaction or transformation during the course of contacting, in situ formation, blending, or mixing operation if conducted in accordance with this disclosure with the application of common sense and the ordinary skill of one in the relevant art (e.g., chemist). The transformation of chemical reactants or starting materials to chemical products or final materials is a continually evolving process, independent of the speed at which it occurs. Accordingly, as such a transformative process is in progress there may be a mix of starting and final materials, as well as intermediate species that may be, depending on their kinetic lifetime, easy or difficult to detect with current analytical techniques known to those of ordinary skill in the art.

Reactants and components referred to by chemical name or formula in the specification or claims hereof, whether referred to in the singular or plural, may be identified as they exist prior to coming into contact with another substance referred to by chemical name or chemical type (e.g., another reactant or a solvent). Preliminary and/or transitional chemical changes, transformations, or reactions, if any, that take place in the resulting mixture, solution, or reaction medium may be identified as intermediate species, master batches, and the like, and may have utility distinct from the utility of the reaction product or final material. Other subsequent changes, transformations, or reactions may result from bringing the specified reactants and/or components together under the conditions called for pursuant to this disclosure. In these other subsequent changes, transformations, or reactions the reactants, ingredients, or the components to be brought together may identify or indicate the reaction product or final material.

The foregoing examples are merely illustrative of some of the features of the invention. The appended claims are intended to claim the invention as broadly as it may have been conceived and the examples herein presented are illustrative of selected embodiments from a manifold of all possible embodiments. Accordingly it is Applicants' intention that the appended claims are not to be limited by the choice of examples utilized to illustrate features of the invention. Where necessary, ranges have been supplied, those ranges are inclusive of all sub-ranges there between. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims.

1. A scintillator composition, comprising:
a matrix having at least one lanthanide ion and at least one halide ion; and
a dopant, comprising:
a trivalent cerium activator ion disposed in the matrix; and
a trivalent bismuth activator ion disposed in the matrix.

2. The scintillator composition as defined in claim 1, wherein the lanthanide ion comprises lutetium.

3. The scintillator composition as defined in claim 2, wherein the lanthanide ion further comprises scandium, yttrium, gadolinium, lanthanum, praseodymium, terbium, europium, erbium, ytterbium, or combinations of two or more thereof.

4. The scintillator composition as defined in claim 1, wherein the scintillator composition is a single crystal.

5. The scintillator composition as defined in claim 3, wherein the portion of lutetium is in a range of from about 80 mole percent to about 100 mole percent.

6. The scintillator composition as defined in claim 1, wherein the halide ion comprises iodine.

7. The scintillator composition as defined in claim 6, wherein the halide ion further comprises fluorine, chlorine, bromine, or combinations of two or more thereof.

8. The scintillator composition as defined in claim 7, wherein the portion of iodine is in a range of from about 95 mole percent to about 100 mole percent.

9. The scintillator composition as defined in claim 1, wherein the dopant is present in an amount in a range of from about 0.1 percent to about 10 percent a mole percent.

10. The scintillator composition as defined in claim 1, wherein the trivalent cerium activator is present in the dopant in a range of from about 0.1 percent to about 10 percent to the total percent of the dopant.

11. The scintillator composition as defined in claim 1, wherein the trivalent bismuth activator is present in the dopant in an amount in a range of from about 0.1 percent to about 10 percent based on the total percent of the dopant.

12. The scintillator composition as defined in claim 1, wherein the scintillator composition is mono-crystalline.

13. The scintillator composition as defined in claim 12, wherein a crystal size of the mono-crystalline scintillator composition is in a range of from about 1 centimeter×1 centimeter to about 10 centimeters×10 centimeters.

14. The scintillator composition as defined in claim 1, wherein the scintillator composition is poly-crystalline.

15. The scintillator composition as defined in claim 14, wherein a crystallite size of the poly-crystalline scintillator composition is in a range of from about 1 micrometer to about 20 micrometers.

16. The scintillator composition as defined in claim 1, wherein the scintillator composition is a wafer.

17. The scintillator composition as defined in claim 1, wherein an attenuation length of the scintillator composition is about 1.7 centimeters for a 511 KeV photon.

18. The scintillator composition as defined in claim 1, wherein a light output of the scintillator composition is in a range of from about 50000 photons per milli electron volt to about 100000 photons per milli electron volt.

19. The scintillator composition as defined in claim 1, wherein a decay time of the scintillator composition is in a range of from about 25 nanoseconds to about 50 nanoseconds.

20. The scintillator composition as defined in claim 1, wherein a rise time of the scintillator composition is in a range of from about 10⁻¹¹ seconds to about 10⁻⁸ seconds.

21. The scintillator composition as defined in claim 1, wherein the lanthanide ion consists essentially of lutetium.

22. The scintillator composition as defined in claim 1, wherein an energy resolution of the scintillator composition is less than about 5 percent.

23. A wafer comprising the scintillator composition as defined in claim 1.

24. The wafer as defined in claim 23, having an average thickness in a range of from about 0.5 centimeters to about 3 centimeters.

25. An article comprising the wafer as defined in claim 23 that is configured to detect radiation if present, and to generate an electronic or optical signal in response to detected radiation.

26. The article as defined in claim 25, wherein the article further comprises a photon detector in optical communication with the wafer.

27. A radiation detector for detecting high-energy radiation, comprising:
a scintillation element having a scintillator composition, the scintillator composition comprising:
a matrix comprising a lanthanide halide, wherein the lanthanide halide comprises at least one lanthanide ion and at least one halide ion;
a dopant comprising a trivalent cerium activator ion disposed in the matrix, and a trivalent bismuth activator ion disposed in the matrix; and
a photon detector optically coupled to the scintillation element and capable of converting photons into electrical signals.

28. The radiation detector as defined in claim 27, wherein the radiation detector is configured for use as a nuclear imaging detector.

29. The radiation detector as defined in claim 27, wherein the radiation detector is configured for use as a positron emission tomography detector.

30. The radiation detector as defined in claim 27, wherein the radiation detector is configured for use as a time-of-flight detector.

31. The radiation detector as defined in claim 27, further comprising a digital imaging device operable to receive the electrical signals.

32. The radiation detector as defined in claim 27, wherein the radiation detector is capable of use as a well-logging tool.

33. The radiation detector as defined in claim 32, further comprising:
a housing capable of accommodating the radiation detector, wherein the housing comprises a transmission window; and
a motor for translating the radiation detector such that the transmission window moves with the radiation detector.

34. The radiation detector as defined in claim 27, wherein the photon detector is a photomultiplier tube, a photodiode, a charge-coupled device (CCD) sensor, or an image intensifier.

35. The radiation detector as defined in claim 27, wherein the radiation detector is in operative association with a screen scintillator.

36. The radiation detector as defined in claim 27, further comprising a portable housing and an energy storage device, which together are sized, weighted, and configured so that the radiation detector is portable by a single person.

37. A method of manufacturing a scintillator composition, comprising:
contacting at least one lanthanide ion precursor and at least one halide ion precursor, a trivalent cerium activator ion precursor, and a trivalent bismuth activator ion precursor to form a mixture having a ratio;
heating the mixture to a temperature to form a molten composition; and
forming a crystalline scintillator composition from the molten composition.

38. The method as defined in claim 36, wherein the lanthanide ion precursor and the halide ion precursor comprise a mixture of lutetium chloride and lutetium bromide; and the trivalent cerium activator ion precursor comprises a cerium halide compound and wherein the trivalent bismuth activator ion precursor comprises a bismuth halide compound.

39. The method as defined in claim 36, wherein contacting comprises grinding or ball milling.

40. The method as defined in claim 36, wherein heating is to a temperature in a range of from about 600 degrees Celsius to about 1050 degrees Celsius.

41. The method as defined in claim 36, wherein forming the crystalline scintillator composition comprises at least one of a Bridgman-Stockbarger method; a Czochralski method, a zone-melting method, a floating zone method, or a temperature gradient method.

42. A method, comprising exposing the scintillator composition as defined in claim 1 to a radiation source.

43. A scintillator composition comprising a reaction product of:
a matrix forming material;
a lanthanide halide precursor; and
a dopant comprising a trivalent cerium activator ion precursor and a trivalent bismuth activator ion precursor.

44. The scintillator composition as defined in claim 42, wherein the lanthanide halide comprises lutetium iodide.

45. The scintillator composition as defined in claim 42, wherein a solid solubility of the trivalent bismuth activator ion in the matrix having a solid solution of the lanthanide halide is in a range of from about 1 mole percent to about 20 mole percent.
